(19) United States
(12) Patent Application Publication
(10) Pub. No.: US 2007/0113484 A1
(43) Pub. Date: May 24, 2007

(54) Modular assembly system

(76) Inventors: Jean T. McGregor, Waxhaw, NC (US); John F. Roberts, Charlotte, NC (US)

Correspondence Address: Giaccherini, Post Office Box 1146, Carmel Valley, CA, 93924, US

(21) Appl. No.: 11/286,142

(22) Filed: Nov. 23, 2005

(51) Int. Cl. B60J 5/04

(52) U.S. Cl. 49/502

(57) ABSTRACT

Methods and apparatus for modular combinations of structural elements (22) and connectors (30) that are sold as a set of unassembled or partially assembled parts (14), and are then transported and assembled by a consumer (10) having ordinary skill without special tools or expertise.

### FEDERALLY SPONSORED RESEARCH OR DEVELOPMENT

None.

### FIELD OF TH INVENTION

The present invention pertains to methods and apparatus for manufacturing, marketing, retailing and assembling modular combinations of structural elements to furnish doors, panels, partitions, walls, enclosures or other constructions. More particularly, one preferred embodiment of the invention utilizes a number of generally planar elements that are assembled by an ordinary-skilled consumer. The invention may be embodied as a door, panel, partition or some other vertically-disposed structure for the home or office. A consumer purchases a relatively small package which contains a stack of the modular elements, transports the package to their home or office in the trunk, back seat or storage compartment of a conventional car or truck, and then assembles the modular elements without using special tools or hiring a contractor.

### BACKGROUND OF THE INVENTION

Every year, Americans purchase millions of doors for homes, offices and places of business. A vast majority of these doors are sold as completed and finished products. Many of these doors are delivered and installed by contractors. Conventional, pre-finished doors that are available at retail outlets like The Home Depot®, Lowe's® or Sears® are generally too large to transport safely in the family car. These conventional doors may also be rather heavy, and are difficult to move and to carry through small areas. Many of these doors require the expertise of a contractor, and can not be put in place without special tools.

No currently available conventional door can be purchased in a package that is easy to carry and transport, and then can be assembled by the consumer without special tools or expertise. The development of such a product would satisfy long felt needs in the home and office furnishings business, and would constitute an advance in the hardware and construction industries.

### SUMMARY OF THE INVENTION

The present invention comprises methods and apparatus for providing structural elements which may be purchased in a kit that is contained in a small portable package. The consumer may purchase this product in a retail store, bring it home in a typical family car, and then assemble and install the product without special tools or expertise.

An appreciation of the other aims and objectives of the present invention, and a more complete and comprehensive understanding of this invention, may be obtained by studying the following description of preferred and alternative embodiments, and by referring to the accompanying drawings.

### A BRIEF DESCRIPTION OF THE DRAWINGS

FIG. 1 shows a family arriving at their local retailer.

FIG. 2 shows the family purchasing an EasyDoor™ Modular Assembly.

FIG. 3 illustrates the ease of transporting the EasyDoor™. After carrying the portable package out to the parking lot, the EasyDoor™ can be stowed in the trunk or in the back seat of a typical family car.

FIGS. 4 and 5 portray the quick and easy installation of the EasyDoor™ by an ordinarily-skilled consumer without special tools or expertise.

FIG. 6 exhibits the installation of alternative embodiments of the invention, which may include customized panels having different interchangeable colors, materials, prints, scenery or popular characters from books, cartoons or movies.

FIGS. 7 and 8 depict the assembly of one basic embodiment of the invention.

FIG. 9 furnishes a view of a connector that may be employed to assembly one of the embodiments of the invention.

FIGS. 10 and 11 depict the assembly of another embodiment of the invention.

FIG. 12 provides a detailed view of the assembly of one embodiment of the invention.

### A DETAILED DESCRIPTION OF PREFERRED & ALTERNATIVE EMBODIMENTS

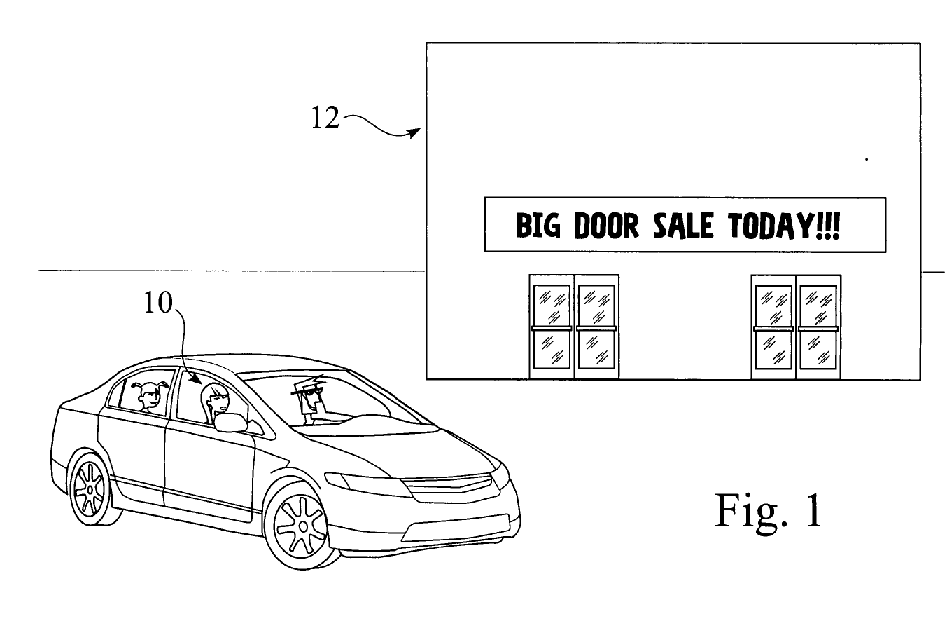

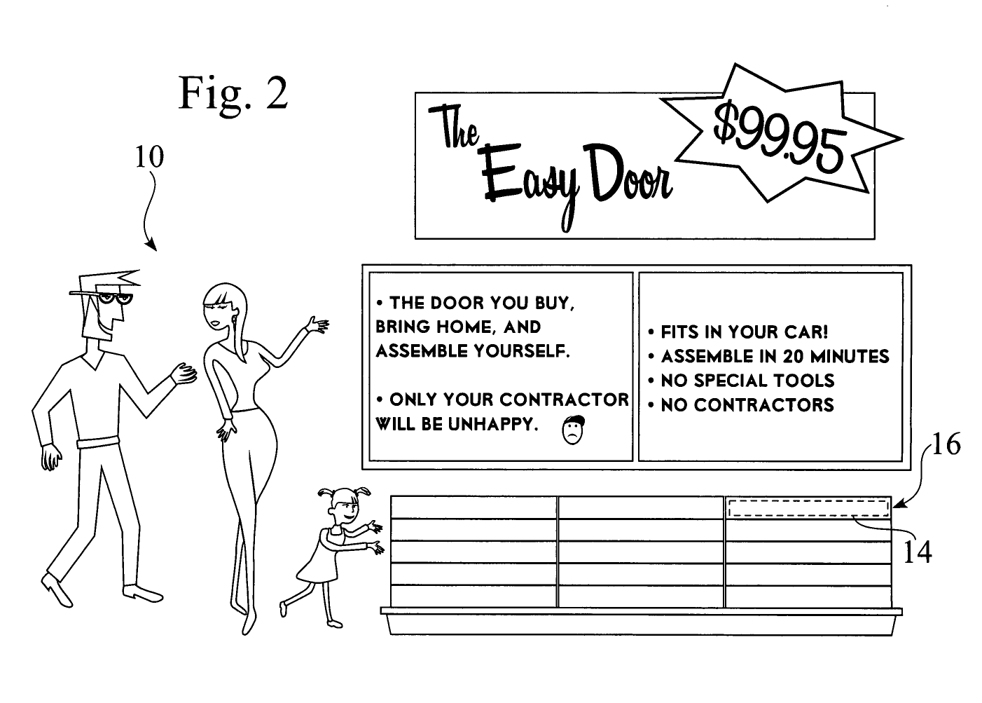

FIG. 1 depicts a family 10 arriving at a local retail store 12. Once inside the store 12, the shoppers 10 find a display for one embodiment of the present invention, the EasyDoor™ 14. As shown in FIG. 2, all the parts of an unassembled door 14 are packaged in a relatively small, portable and easy-to-transport package 16 that has its own carrying handle.

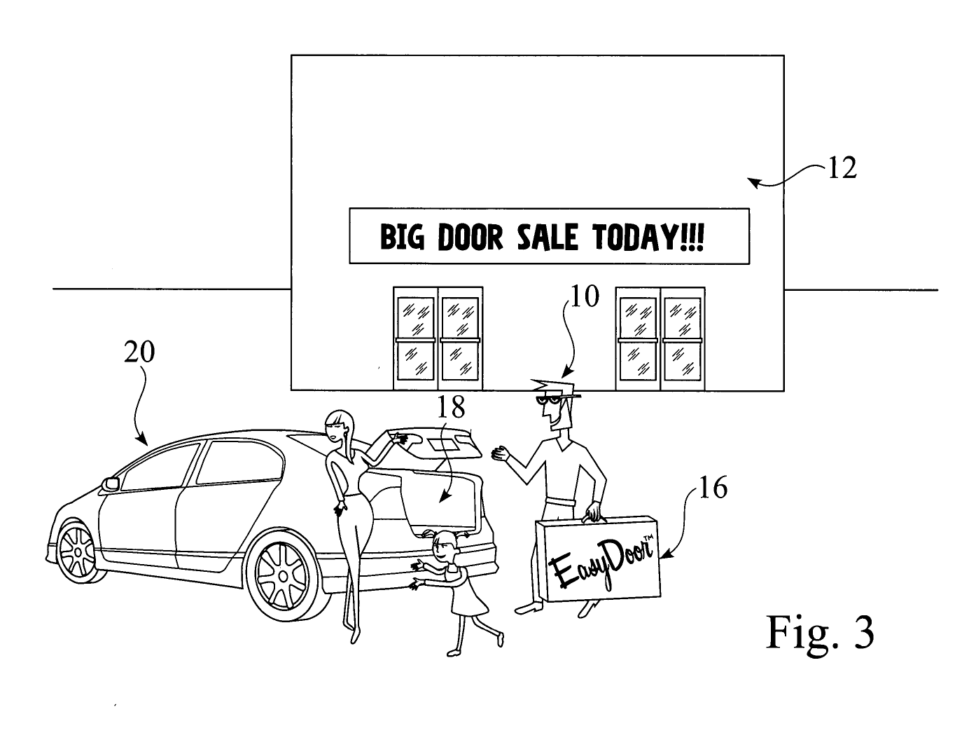

FIG. 3 shows the family 10 returning to the parking lot outside the retail store 12, where the EasyDoor™ package 16 is stowed in the trunk 18 of a typical family car 20. In this embodiment, the package 16 is so compact that it can even be carried inside the passenger compartment of the car 20.

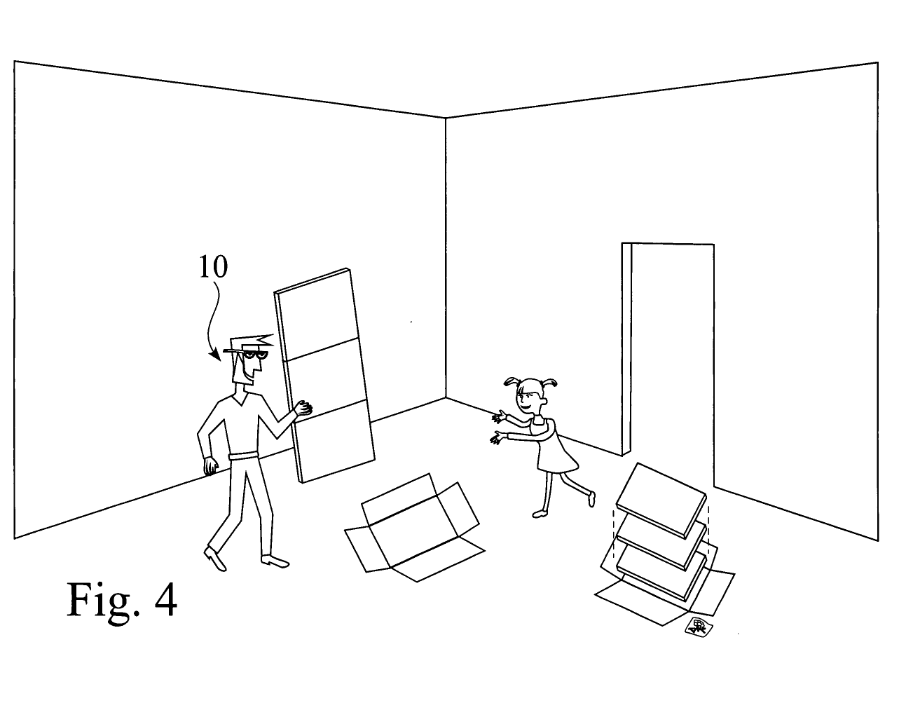

After arriving back home, the family 10 is ready to install the EasyDoor™ 14 as the interior entry door to Janie's room, as shown in FIG. 4. All of the components and connectors for the door are arranged in a stack in a package. The parts may be unassembled, or partially assembled. A typical size for the box containing this door is approximately two feet wide by three feet long by six inches high.

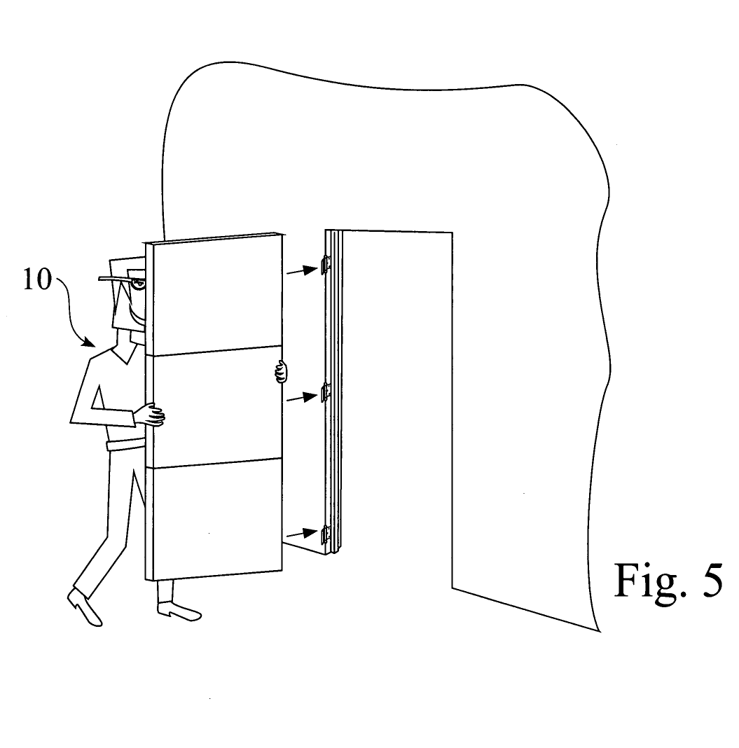

In this embodiment of the invention, the packaging 16 is opened and the components of the EasyDoor™ 14 are assembled by the consumer with ordinary skill without any special tools or expertise. Due to the compact size of the components, the door may be assembled in a small room without any special table or workbench. The components are fitted together either on the floor, or may be leaned against a wall as it is constructed, as shown in FIG. 5. The assembled door may be installed on hinges, hung on a track with rollers or guides, or attached to a door frame in any suitable fashion with various types of hardware. Other embodiments of the invention may include bi-fold doors or stationary panels.

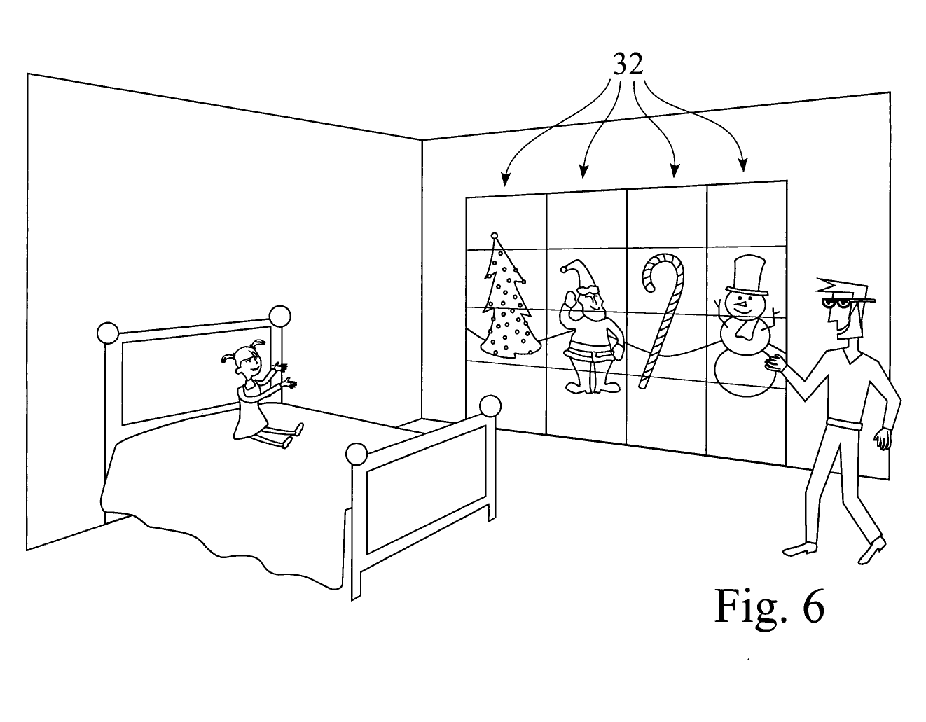

FIG. 6 offers a view of an alternative embodiment of the invention, which may include doors having:
panels with different color combinations, finishes or different materials;
sections with printed or painted scenes; or
surfaces bearing various illustrations of characters from books, cartoons or films.

This feature is especially beneficial for doors or panels installed in the rooms of children, who may wish to change the colors or scenes on door panels frequently to display favorite characters from popular books or movies.

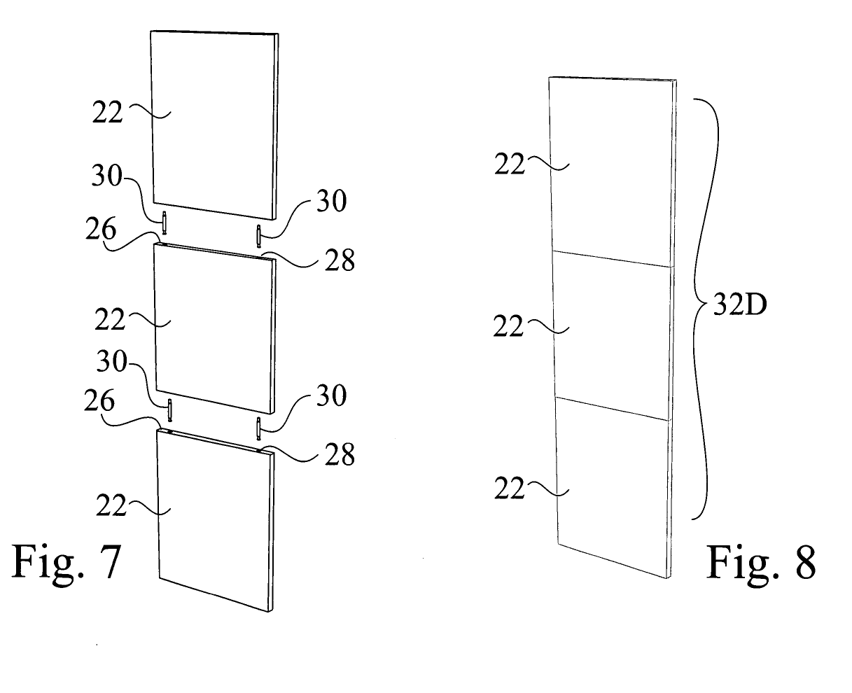

FIG. 7 furnishes an illustration of the components of one embodiment of the invention. In general, the present invention comprises one or more primary elements 22 and one or more secondary elements 24 (which may be optional, and which are described below). In general, each primary element 22 includes at least one transverse surface 26. In this Specification and in the Claims that follow, the term “transverse” is meant to connote any line, plane or surface that generally runs from side to side, including any horizontal or diagonal that is either parallel to the floor or to the ground, or forms an angle with the floor or ground that is less than ninety degrees. In one embodiment of the invention, when primary elements 22 are assembled, each transverse surface 26 is generally parallel to the floor or to the ground. In general, each primary element 22 has a transverse surface 26 which has a hole 28 that is configured to receive a connector 30. The term “hole” is intended to encompass a recess, mortise, slot, hollow, or any other suitable negative or evacuated space that is capable of receiving a connector 30. In an alternative embodiment, other alternative joining methods may be utilized, including glues, adhesives, epoxies and suitable types of compression fittings or other “snap-together” hardware.

In general, when primary elements 22 are combined with connectors 30, the result is a fully assembled structure 32. In some embodiments, the assembled structure 32 may also include secondary elements 24. These secondary elements may include rails 24r and stiles 24s, and are described below. In another embodiment of the invention, these transverse surfaces may be aligned diagonally, meaning that they form an angle with the floor or ground that is less than ninety degrees.

As an example, one of the particular embodiments of the invention is a door 32D. In this Specification and in the Claims that follow, the general reference character “32” pertains to a wide variety of assembled structures. More specific reference characters which include “32” and a capital letter, such as “32D,” pertain to a particular embodiment of the more generalized term “structure.”

In one embodiment of the invention which is portrayed in FIGS. 7 and 8, a door 32D generally comprises a combination of panels 22 and connectors 30. In this example, the panels 22 are the primary elements. Panels 22 are generally planar, rectangular sections that may be fabricated from natural wood, plywood, particle board, paper-wrapped chipboard, heavy paper, drywall, plastic, composite, glass, mirror, metal (such as aluminum) or any other suitable natural or man-made material. In this example, each panel 22 has the same width, measuring across from side to side along a line that is generally parallel to the floor. This type of panel 22 includes two transverse surfaces 26, which are the narrow top and bottom surfaces which are parallel to the floor when the door 32D is assembled. These transverse surfaces 26 are generally flat, and include holes 28 for connectors 30 that hold the finished door 32D together as a single unit. The connectors 30 may include dowels, rods, cylinders, pins, shafts, pegs, tenons, screws, bolts, brackets or any suitable projection, member, protuberance, appendage or mechanical coupling, engaging, grasping, bonding, joining, holding, locking, retaining or affixing means or a some device that snaps or presses together.

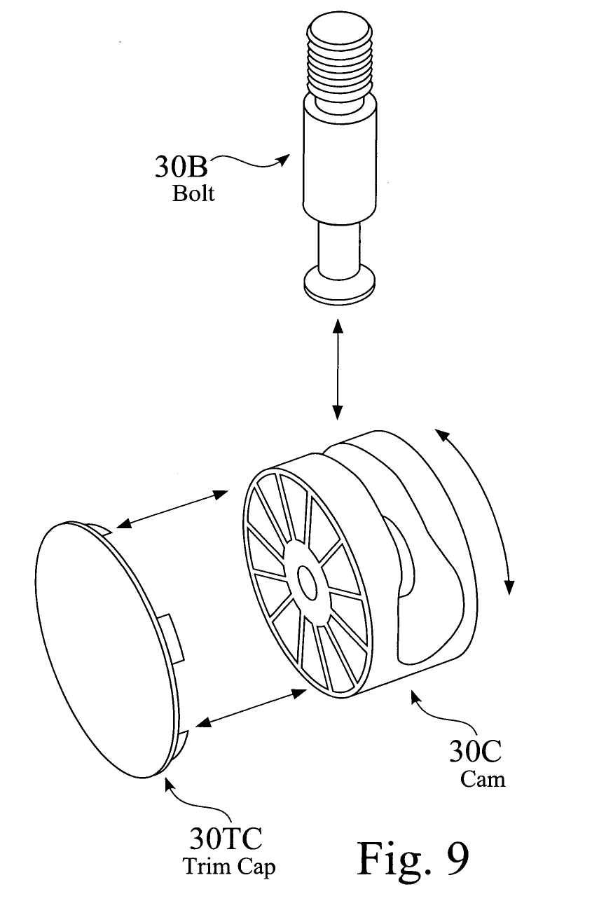

Specific examples of connectors 30 that may be utilized to implement the present invention are shown in FIG. 9. In one embodiment, cam and bolt connectors manufactured by Häfele of Archdale, N.C. may be used as connectors 30 to implement the present invention. This combination of a cam 30C and a bolt 30B (and an optional trim cap 30TC) are sometimes referred to as a “cam lock.” In general, a cam lock comprises two members that fit together, and then one of the members is twisted or rotated to supply a strong mechanical connection. The Häfele Maxiflix Universal Connector shown in FIG. 9 is composed of metal, but the connector employed by the present invention may be fashioned from wood, plastic or any other suitable material.

In another embodiment of the invention, some connectors 30 may be preinstalled, preset or pre-glued in the holes 28.

The particular embodiment of the door 32D shown in FIGS. 7 and 8 is assembled without special tools or carpentry skills. After opening the package 16, the consumer 10 removes a stack of three panels 22 and a set of connectors 30, which may be enclosed in a plastic bag. The three panels 22 may be placed on the floor in a row, so that the side edges of the three panels are aligned along the same line. The consumer 10 then inserts the connectors 30 in the holes 28 that have been pre-drilled in the transverse surfaces 26 of the panels 22. The top and bottom of the three panels 22 are then moved toward the center of the three panels 22, to engage the connectors 30.

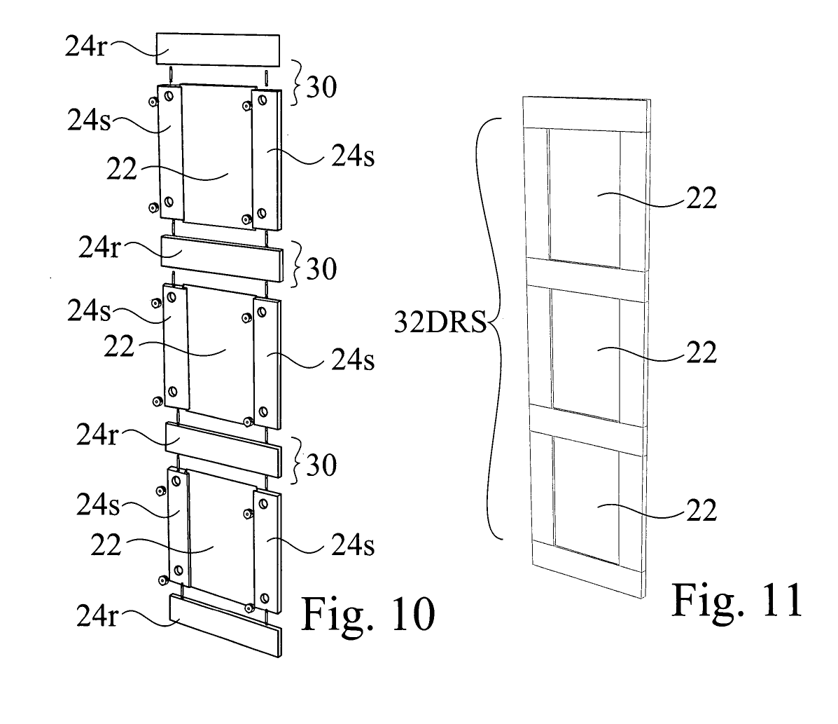

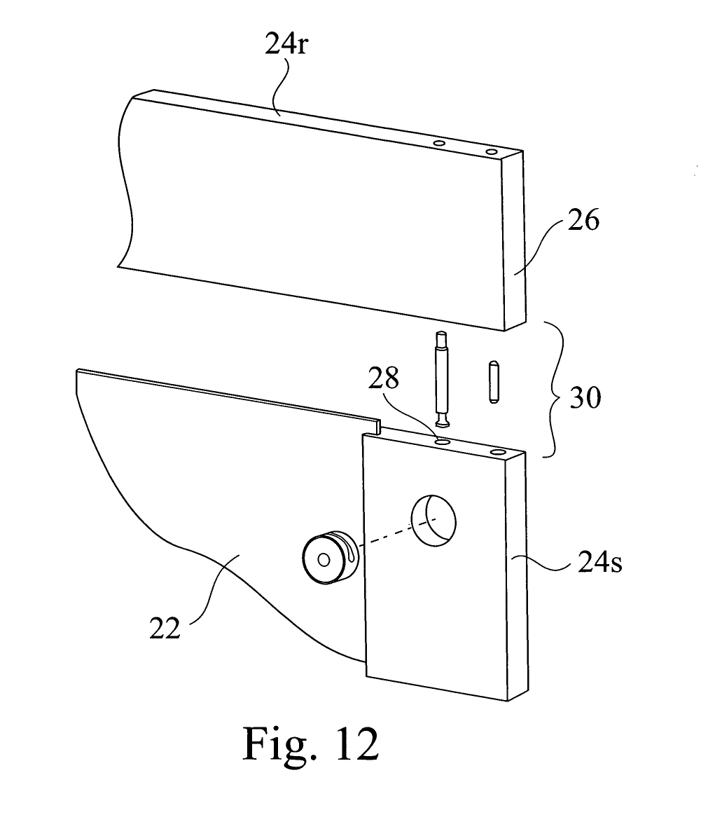

In an alternative embodiment, the door may also include secondary elements 24, such as rails 24r and stiles 24s. In general, a rail 24r is a horizontal element that abuts a panel 22. In general, a stile 24s is a vertical element that abuts a panel 22. In one embodiment, stiles 24s and 24r rails include a groove to insert a panel of a desired material. This embodiment is illustrated in FIGS. 10 and 11. The completed product with rails 24r and stiles 24s is shown as door 32DRS. The assembly procedure for this embodiment 32DRS is generally the same as the more basic embodiment 32D, except that additional elements 24r and 24s are assembled around the panels. A detailed view of the assembly of one embodiment of the invention is shown in FIG. 12.

An assembled door 32D or 32DRS may be installed using any suitable hardware, such as hinges, hangers, rails, tracks, guides or rollers. A new assembled door 32D or 32DRS may be mounted on existing or on new hardware.

This implementation of the invention may also be supplemented with other hardware, such as knobs, handles, entry lock sets. One of the panels in the unassembled kit may have a preformed hole to accept a knob or handle.

The apparatus and methods that are utilized to construct the door embodiments 32D and 32DRS of the present invention may be extended to all types of doors, including entry doors, closet doors, pocket doors, folding doors, saloon doors, sliding doors, interior doors and exterior doors.

In other embodiments, the apparatus and methods of the invention may be implemented in the general form of a desk, chair, table, bookcase, cabinet, storage box, bed, countertop, window or any other manifestation of furniture, furnishing or element of a building, shelter, enclosure or structure.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for providing a Modular Assembly System that have been disclosed above are intended to educate the reader about preferred embodiments of the invention, and are not intended to constrain the limits of the invention or the scope of Claims.

### LIST OF REFERENCE CHARACTERS

10 Family
12 Retail store
14 EasyDoor™ (unassembled in box)
16 Easy to carry package
18 Trunk
20 Family car
22 Primary element (panel)
24 Secondary element
24r Rail
24s Stile
26 Transverse surface
28 Hole
30 Connector
30B Bolt
30C Cam
30TC Trim cap
32 Assembled structure
32D Assembled door
32DRS Assembled door with rails and stiles

What is claimed is:

1. A method comprising the steps of:
providing a plurality of panels (22) and connectors (30) in stacked in an easy-to-carry package (16); and
assembling said plurality of panels (22) using a plurality of connectors (30) without special tools.

2. A method as recited in claim 1, in which
each of said plurality of panels (22) includes two transverse surfaces (26).

3. A method as recited in claim 2, in which
each of said panels (22) includes a plurality of preformed holes (28) in one of said transverse surfaces (26).

4. A method as recited in claim 3, in which
each of said connectors (30) is inserted into one of said preformed holes (28) in said transverse surfaces (26) of said plurality of panels (22);

5. A method as recited in claim 1, in which
said package (10) is transported by said consumer (10).

6. A method as recited in claim 1, in which
said plurality of panels (22) and said plurality of connectors (30) are assembled by said consumer (10).

7. A method as recited in claim 1, in which
in which said plurality of panels (22) are generally planar.

8. A method as recited in claim 1, in which
said plurality of panels (22) are manufactured from natural wood.

9. A method as recited in claim 1, in which
said plurality of panels (22) are manufactured from particle board.

10. A method as recited in claim 1, in which
said plurality of panels (22) are manufactured from paper-wrapped chipboard.

11. A method as recited in claim 1, in which
said plurality of panels (22) are manufactured from plastic.

12. A method as recited in claim 1, in which
said plurality of panels (22) are manufactured from metal.

13. A method as recited in claim 1, in which
said plurality of panels (22) include a surface bearing a printed photo.

14. A method as recited in claim 1, in which
said plurality of panels (22) include a surface bearing printed scenery.

15. A method as recited in claim 1, in which
transporting said package (16) using a conventional passenger car (20).

16. A method as recited in claim 1, in which
said transverse surfaces (26) are generally flat.

17. A method as recited in claim 1, which
also includes a rail (24r).

18. A method as recited in claim 1, which
also includes a stile (24s).

19. A method as recited in claim 1, in which
said connectors (30) are cam locks.

20. A method as recited in claim 1, in which said plurality of panels (22), when assembled, are installed in a generally vertical position.

21. An apparatus comprising:
a plurality of panels (22); each of said panels (22) including two transverse surfaces (26);
each of said panels (22) having a plurality of preformed holes (28) in one of said transverse surfaces (26);
a plurality of connectors (30);
each of said connectors (30) for insertion into one of said preformed holes (28) in said transverse surfaces (26) of said plurality of panels (22);
said plurality of panels (22) and said plurality of connectors (30) being arranged in a stack before purchase by a consumer (10); and
a package (16); said package (16) for housing said stack;
said package (16) being sold to said consumer (10);
said package (10) being transportable by said consumer (10);
said plurality of panels (22) and said plurality of connectors (30) being assembled by said consumer (10) without special tools.

22. An apparatus as recited in claim 21, in which said plurality of panels (22) are generally planar.

23. An apparatus as recited in claim 21, in which said plurality of panels (22) are manufactured from natural wood.

24. An apparatus as recited in claim 21, in which said plurality of panels (22) are manufactured from particle board.

25. An apparatus as recited in claim 21, in which said plurality of panels (22) are manufactured from paper-wrapped chipboard.

26. An apparatus as recited in claim 21, in which said plurality of panels (22) are manufactured from plastic.

27. An apparatus as recited in claim 21, in which said plurality of panels (22) are manufactured from metal.

28. An apparatus as recited in claim 21, in which said plurality of panels (22) include a surface bearing a printed photo.

29. An apparatus as recited in claim 21, in which said plurality of panels (22) include a surface bearing printed scenery.

30. An apparatus as recited in claim 21, in which said transverse surfaces (26) are generally flat.

31. An apparatus as recited in claim 21, further comprising a rail (24r).

32. An apparatus as recited in claim 21, further comprising a stile (24s).

33. An apparatus as recited in claim 21, in which said connector (30) is a cam lock.

34. An apparatus as recited in claim 21 which, when assembled, is installed in a generally vertical position.
